(19) United States
(12) Patent Application Publication
(10) Pub. No.: US 2024/0326473 A1
(43) Pub. Date: Oct. 3, 2024

(54) PRINTING SYSTEM

(71) Applicant: SEIKO EPSON CORPORATION, Tokyo (JP)

(72) Inventors: Ryuji MORIYAMA, MATSUMOTO-SHI (JP); Yoshihiko MOMOSE, SHIOJIRI-SHI (JP); Yoichi KOBAYASHI, MATSUMOTO-SHI (JP)

(21) Appl. No.: 18/614,846

(22) Filed: Mar. 25, 2024

(30) Foreign Application Priority Data
Mar. 27, 2023 (JP) 2023-049468

(51) Int. Cl. B41J 11/00; B41J 2/21; C09D 11/101

(52) U.S. Cl. CPC B41J 11/00214; B41J 2/2107; B41J 11/0022; C09D 11/101

(57) ABSTRACT

A printing system includes a printing unit that includes a printing head configured to discharge UV curable ink from a plurality of nozzles to a medium and is configured to execute printing, a deodorizing unit configured to suck odor generated from the UV curable ink, and a control unit configured to control the printing unit and the deodorizing unit. The control unit controls suction by the deodorizing unit according to any one of an operation of the printing unit, print data input from outside for printing, and an operation on the printing unit by a user.

The present application is based on, and claims priority from JP Application Serial Number 2023-049468, filed Mar. 27, 2023, the disclosure of which is hereby incorporated by reference herein in its entirety.

### BACKGROUND

### 1. Technical Field

The present disclosure relates to a printing system using a UV curable ink.

### 2. Related Art

In an ink jet printer using a UV curable ink, the ink is cured and fixed to a medium by irradiating the UV curable ink discharged to the medium by a printing head with ultraviolet rays. UV is an abbreviation for Ultra Violet. Since the UV curable ink generates a unique odor, it is necessary to remove the odor.

As a related art, there is disclosed a printing apparatus including a printing unit that performs printing on a printing target, a housing that accommodates the printing unit, a gas cleaning unit that cleans gas, and a discharge unit that couples the housing and the gas cleaning unit and discharges gas in the housing to the gas cleaning unit (see JP-A-2018-140530).

According to the related art, ventilation or gas cleaning for deodorizing odor generated from ink has been performed only by a user manually activating a device responsible for deodorization. Alternatively, the user may manually set the suction force and time of the device responsible for such deodorization. However, in view of printing and various operations and situations related to printing, deodorizing operations executed have been excessive, insufficient, or not reasonable. Therefore, it is difficult to say that appropriate deodorization according to the situation can be performed.

### SUMMARY

A printing system includes a printing unit that includes a printing head configured to discharge UV curable ink from a plurality of nozzles to a medium and configured to execute printing, a deodorizing unit configured to suck odor generated from the UV curable ink, and a control unit configured to control the printing unit and the deodorizing unit. The control unit controls suction by the deodorizing unit according to any one of an operation of the printing unit, print data input from outside for printing, and an operation on the printing unit by a user.

### BRIEF DESCRIPTION OF THE DRAWINGS

FIG. 1A is a diagram schematically illustrating a printing system of the first type, FIG. 1B is a diagram schematically illustrating a printing system of the second type, and FIG. 1C is a diagram schematically illustrating a printing system of the third type;

FIG. 2 is a diagram schematically illustrating the configuration of a printing apparatus;

FIG. 3 is a diagram schematically illustrating a configuration including a printing head and a medium from a viewpoint from above;

FIG. 4A is a view for explaining an example of the movement of a carriage with respect to a medium, and FIG. 4B is a view schematically illustrating a configuration in which first and second deodorizing units are disposed in the housing of the printing apparatus from a viewpoint from above;

FIG. 5 is a flowchart illustrating Example 1;

FIG. 6 is a flowchart illustrating Example 2; and

FIG. 7 is a flowchart illustrating Example 5.

### DESCRIPTION OF EMBODIMENTS

Embodiments of the present disclosure will be described below with reference to the accompanying drawings. Note that each figure is merely illustrative for describing the present embodiment. Since each drawing is an example, ratios and shapes may not be accurate, may not match each other, or may be partially omitted.

### 1. SYSTEM CONFIGURATION

A printing system 10 according to the present embodiment includes a printing unit 20 that has a printing head that discharges so-called UV curable ink from a plurality of nozzles to a medium and executes printing, a deodorizing unit 40 that suctions odor generated from the UV curable ink, and a control unit 12 that controls the printing unit 20 and the deodorizing unit 40. Hereinafter, the UV curable ink is also simply referred to as ink.

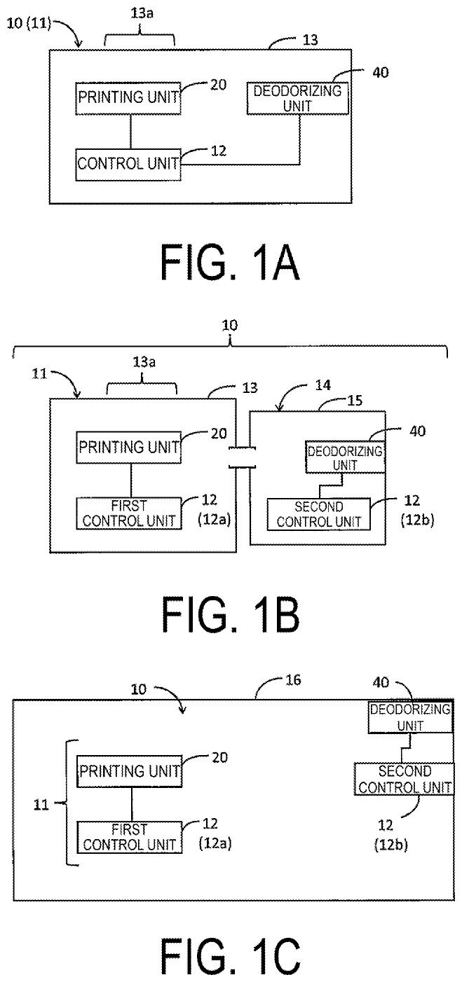

FIG. 1A schematically illustrates the printing system 10 of the first type. As illustrated in FIG. 1A, the deodorizing unit 40 is disposed in a housing 13 together with the printing unit 20 and the control unit 12. That is, the printing system 10 of the first type is a single printing apparatus 11, and the deodorizing unit 40 is incorporated in the housing 13 of the printing apparatus 11. The deodorizing unit 40 includes a suction fan for sucking air containing odor in the housing 13 and a filter and a deodorizer for deodorizing and cleaning the air sucked into the deodorizing unit 40 by the suction fan. The air deodorized by the deodorizing unit 40 is discharged to the outside.

The control unit 12 is communicably connected to each of the printing unit 20 and the deodorizing unit 40. The printing unit 20 performs printing and other operations under the control of the control unit 12. The driving of the suction fan of the deodorizing unit 40 is controlled by the control unit 12, so that the suction force of the deodorizing unit 40 is variable.

FIG. 1B schematically shows the printing system 10 of the second type. With respect to the second type and the third type described later, differences from the first type will be mainly described. According to FIG. 1B, the printing unit 20 and a first control unit 12a that controls the printing unit 20 are accommodated in the housing 13 of the printing apparatus 11. A housing 15 different from the housing 13 houses the deodorizing unit 40 and a second control unit 12b for controlling the deodorizing unit 40, and the housing 15 and the inside of the housing 15 can be regarded as one deodorizing device 14.

That is, the printing system 10 of the second type includes the printing apparatus 11 and the deodorizing device 14. According to FIG. 1B, the inside of the housing 13 of the printing apparatus 11 and the inside of the housing 15 of the deodorizing device 14 partially communicate with each other, and odor inside the housing 13 is deodorized by the deodorizing unit 40 through the communication of such a space. The suction fan of the deodorizing unit 40 is driven by the second control unit 12b, and the suction force of the deodorizing unit 40 is variable. The first control unit 12a and the second control unit 12b are communicably connected to each other in a wired or wireless manner. The first control unit 12a instructs the second control unit 12b to control the suction of the deodorizing unit 40 in accordance with various situations on the printing apparatus 11 side, and the second control unit 12b controls the suction of the deodorizing unit 40 in accordance with the instruction transmitted from the first control unit 12a.

FIG. 1C schematically shows a printing system 10 of the third type. According to FIG. 1C, the printing apparatus 11 is installed in a certain room 16. The printing apparatus 11 includes the printing unit 20 and the first control unit 12a that controls the printing unit 20. In the printing system 10 of the third type, the printing apparatus 11 does not include a housing that covers the printing unit 20 including a printing head and the like. Therefore, the odor generated from the printing unit 20 remains in the room 16, and the deodorizing unit 40 is installed in the room 16 to suck the odor. The deodorizing unit 40 in the third type may be understood as a ventilation device for sucking air in the room 16 and discharging the air to the outside of the room. Also in the third type, the deodorizing unit 40 is controlled by the first control unit 12a via the second control unit 12b. The relationship between the first control unit 12a and the second control unit 12b is as described with reference to the second type.

In the printing system 10 of the second type or the third type, the first control unit 12a and the second control unit 12b correspond to the control unit 12 according to the present embodiment. Hereinafter, the first control unit 12a and the second control unit 12b will be collectively described as the control unit 12 without being particularly distinguished from each other.

Since the printing system 10 may be any of the first, second, and third types, the present embodiment will be described without basically specifying which type the printing system 10 is. However, the type of printing system 10 employed may be specified and described as needed.

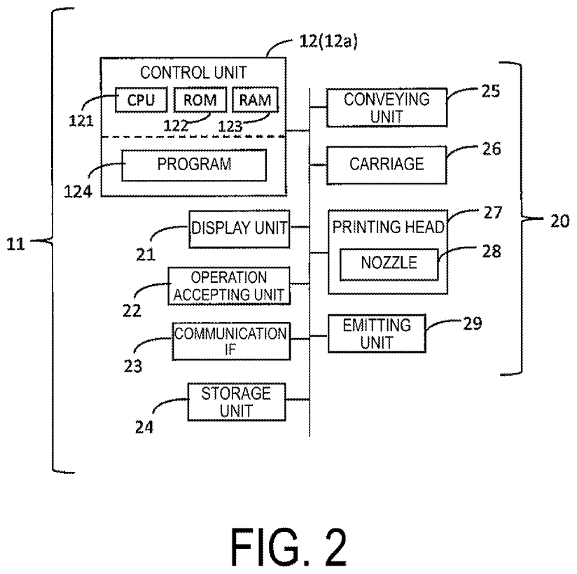

FIG. 2 schematically illustrates the configuration of the printing apparatus 11. As described above, the printing apparatus 11 includes the control unit 12 and the printing unit 20. When the printing system 10 is of the second type or the third type, the control unit 12 of the printing apparatus 11 is the first control unit 12a. The printing apparatus 11 includes a display unit 21, an operation accepting unit 22, a communication IF 23, a storage unit 24, a conveying unit 25, a carriage 26, a printing head 27, an emitting unit 29, and the like. IF is an abbreviation for interface. If the printing system 10 is of the first type, the printing apparatus 11 naturally includes the deodorizing unit 40 although not shown in FIG. 2.

The control unit 12 includes one or a plurality of ICs, each including a CPU 121 as a processor, a ROM 122, a RAM 123, and the like, other nonvolatile memories, and the like. In the control unit 12, the processor, that is, the CPU 121, executes arithmetic processing according to one or more programs 124 stored in the ROM 122, other memories, or the like using the RAM 123 or the like serving as a work area, thereby controlling the printing system 10. Also, the processor is not limited to a single CPU, and a configuration in which the processing is performed by a hardware circuit such as a plurality of CPUs, an ASIC, or the like may be adopted, or a configuration in which a CPU and a hardware circuit cooperate to perform the processing may be adopted.

The display unit 21 is a unit that displays visual information and is configured by, for example, a liquid crystal display, an organic EL display, or the like. The display unit 21 may have a configuration including a display and a drive circuit for driving the display. The operation accepting unit 22 is a unit that receives an operation performed by a user and is realized by, for example, a physical button, a touch panel, a mouse, a keyboard, or the like. Obviously, the touch panel may be realized as one function of the display unit 21.

The communication IF 23 is a general term for one or a plurality of IFs for coupling the printing apparatus 11 to an external device in a wired or wireless manner in accordance with a predetermined communication protocol including known communication standards. The external device includes, for example, various types of communication devices such as a personal computer, a server, a smartphone, and a tablet type terminal. In the case of the second type or the third type, the deodorizing unit 40 and the second control unit 12b also correspond to a type of external device when viewed from the printing apparatus 11.

The storage unit 24 is configured of, for example, a storage device such as a hard disk drive or a solid state drive. The storage unit 24 may be one memory included in the control unit 12. The storage unit 24 may be understood as part of the control unit 12. The storage unit 24 stores various types of information required for controlling the printing system 10.

In the example in FIG. 2, the printing unit 20 includes the conveying unit 25, the carriage 26, the printing head 27, and the emitting unit 29.

The conveying unit 25 is a unit that conveys a medium in a predetermined “conveying direction” and includes, for example, rotating rollers and motors for rotating the rollers and the like. The medium is typically paper, but in addition to paper, various materials that can be a target of printing with ink, such as fabrics and films, can be adopted as the medium. The conveying direction is also referred to as a sub-scanning direction. The conveying unit 25 may be a mechanism that conveys a medium by placing it on a belt, a pallet, or a tray.

The carriage 26 is a mechanism that can reciprocate in a predetermined main scanning direction by receiving power from a carriage motor (not illustrated). The main scanning direction and the sub-scanning direction intersect each other. The intersection between the main scanning direction and the sub-scanning direction may be understood as being orthogonal or substantially orthogonal. The printing head 27 is mounted at the carriage 26. Accordingly, the printing head 27 reciprocates in the main scanning direction together with the carriage 26. The movement of the printing head 27 and the movement of the carriage 26 are synonymous.

The printing head 27 has a plurality of nozzles 28 discharge ink. The nozzle 28 discharges dots which are liquid droplets. The printing head 27 discharges ink based on print data for printing an image under the control of the control unit 12. As is known, the control unit 12 controls application of drive signals to drive elements (not illustrated) included in each of the nozzles 28 in accordance with the print data to cause each of the nozzles 28 to discharge or not to discharge the dots, thereby printing an image on the medium.

The printing head 27 can discharge color inks of respective colors such as cyan (C), magenta (M), yellow (Y), and black (K). Of course, the ink discharged by the printing head 27 is not limited to CMYK. Further, the printing head 27 can also discharge transparent ink called varnish ink as a protective agent or a finishing agent. The print data is data defining discharge or non-discharge of dots for each pixel and each ink type. The discharge of dots is also referred to as dot-on, and the non-discharge of dots is also referred to as dot-off.

The emitting unit 29 is a light capable of irradiating the ink discharged onto the medium by the printing head 27 with ultraviolet light. The emitting unit 29 is, for example, an LED light. The ink irradiated with ultraviolet light is cured and fixed to the medium. The emission of ultraviolet rays by the emitting unit 29 to irradiate ink with ultraviolet rays is hereinafter also simply referred to as irradiation.

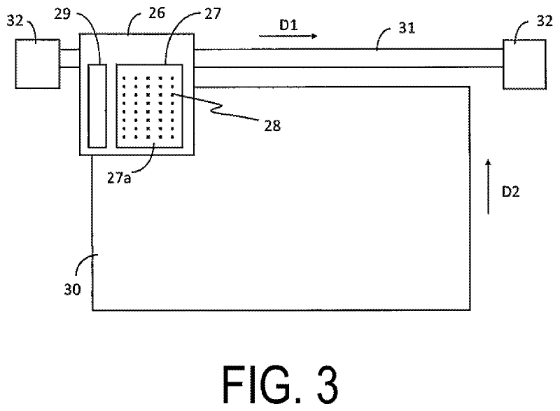

FIG. 3 is a diagram schematically illustrating the configuration including the printing head 27 and a medium 30 from a viewpoint from above. The carriage 26 moves along a rail 31 parallel to a main scanning direction D1 while being supported by the rail 31. Accordingly, the printing head 27 mounted on the carriage 26 reciprocates along the main scanning direction D1 together with the carriage 26. In FIG. 3, the plurality of nozzles 28 on a nozzle surface 27a are very simply indicated by black dots. The nozzle surface 27a is the lower surface of the printing head 27, and each nozzle 28 is open in the nozzle surface 27a. The printing head 27 has a plurality of nozzle rows in which the plurality of nozzles 28 are arranged in a sub-scanning direction D2. Each of the plurality of nozzle rows corresponds to the discharge of any type of ink such as C, M, Y, or K ink or varnish ink.

The operation in which the printing head 27 discharges ink together with the movement of the carriage 26 along the main scanning direction D1 is referred to as main scanning. Main scanning may be referred to as a pass. The relative movement of the printing head 27 and the medium 30 in the sub-scanning direction D2 between passes is referred to as sub-scanning. That is, sub-scanning is performed by the conveying unit 25 conveying the medium 30 by a predetermined distance in the sub-scanning direction D2. The control unit 12 controls the carriage 26, the printing head 27, and the conveying unit 25 to execute a pass and sub-scanning, thereby printing a two-dimensional image on the medium 30.

The printing unit 20 may not be provided with the conveying unit 25 that conveys the medium 30. The carriage 26 may be capable of reciprocating not only along the main scanning direction D1 but also along the sub-scanning direction D2. For example, it is assumed that a support portion 32 supporting the rail 31 at a position above the medium 30 is configured to reciprocate along the sub-scanning direction D2 by a moving mechanism (not shown). That is, the support portion 32, the rail 31, the carriage 26, and the printing head 27 integrally reciprocate along the sub-scanning direction D2. Instead of conveying the medium 30, sub-scanning may be performed by moving the carriage 26 in the sub-scanning direction D2 on the stationary medium 30.

In the example in FIG. 3, the emitting unit 29 is mounted at the carriage 26 together with the printing head 27. Therefore, similarly to the relationship between the printing head 27 and the medium 30, the emitting unit 29 can also irradiate each position of the medium 30 by changing the position relative to the medium 30. In FIG. 3, the emitting unit 29 is mounted only on one end side in the main scanning direction D1 with respect to the printing head 27, but the emitting units 29 may be mounted at two positions so as to sandwich the printing head 27 from both sides in the main scanning direction D1. Of course, the configuration in which the emitting unit 29 is mounted at the carriage 26 is an example. If the printing unit 20 is configured to include the conveying unit 25, the emitting unit 29 can irradiate the medium 30 after printing by the printing head 27 by providing the emitting unit 29 at a downstream position of the printing head 27 in the conveying direction.

### 2. CONTROL OF DEODORIZING UNIT

The control unit 12 controls the suction by the deodorizing unit 40 according to any one of an operation of the printing unit 20, printing data input from the outside for printing, and an operation on the printing unit 20 by a user. Each Example of the control of the deodorizing unit 40 will be described below. Combinations of a plurality of Examples are naturally included in the disclosure scope of the present embodiment.

### 2-1. Example 1

As described above, a printing unit 20 includes an emitting unit 29. A control unit 12 increases more the suction force of a deodorizing unit 40 at the time of performing the second operation of performing only irradiation between the discharge of the ink by a printing head 27 and irradiation by the emitting unit 29 than at the time of performing the first operation of simultaneously performing discharge of ink by the printing head 27 and irradiation by the emitting unit 29. That is, each of the first operation and the second operation is a kind of operation of the printing unit 20, and the control of the deodorizing unit 40 is made different according to the first operation and the second operation.

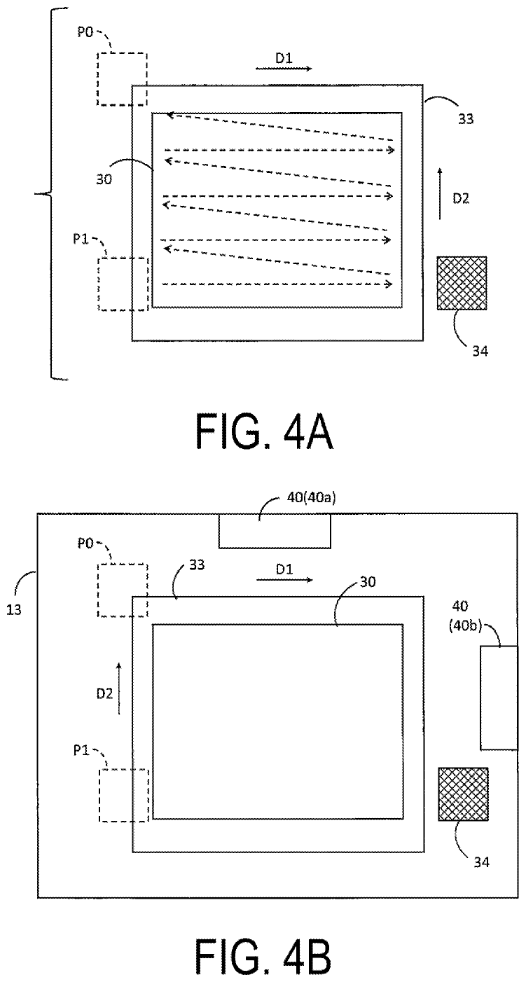

FIG. 4A is a view for explaining an example of the movement of a carriage 26 with respect to one medium 30 from the same viewpoint as in FIG. 3. In the example in FIG. 4A, the medium 30 is not conveyed, and the carriage 26 is movable also in the sub-scanning direction D2 as described above. Reference numeral 33 denotes a table 33 on which the medium 30 to be processed is placed. One sheet of the medium 30 is placed at the table 33. A predetermined position P0 indicated by a broken-line rectangle is an initial position P0 of the carriage 26, and the carriage 26 stands by at the initial position P0 when printing, irradiation, or the like is not executed. The initial position P0 is, for example, a position on the downstream side in the sub-scanning direction D2 with respect to the table 33 and on one end side or the other end side in the main scanning direction D1.

When printing or irradiation is started, the control unit 12 moves the carriage 26 from the initial position P0 to a predetermined start position P1. The start position P1 is, for example, a position on the upstream side in the sub-scanning direction D2 as viewed from the initial position P0 and is a position where ink can be discharged from the printing head 27 with respect to the end portion on the upstream side of the medium 30 in the sub-scanning direction D2. The carriage 26 that has moved to the start position P1 then moves evenly over the medium 30 by a combination of movement along the main scanning direction D1 and movement along the sub-scanning direction D2 and finally returns to the initial position P0, as schematically indicated by the broken-line arrow in FIG. 4A.

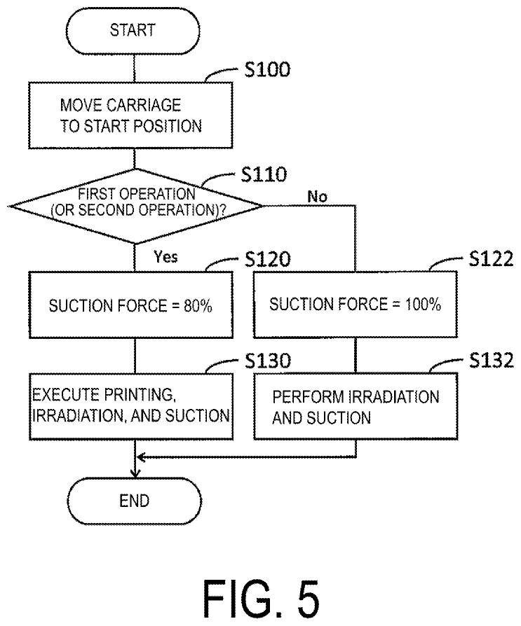

FIG. 5 is a flowchart illustrating Example 1. The control unit 12 executes the flowchart in FIG. 5 when starting processing for one medium 30 in response to an instruction through the operation of an operation accepting unit 22 by the user or an instruction through a communication IF 23 from an external device.

In step S100, the control unit 12 moves the carriage 26 from the initial position P0 to the start position P1.

In step S110, the control unit 12 determines whether or not to perform the first operation, that is, which of the first operation and the second operation is to be performed. If the execution instruction of the first operation is received, it is determined as “Yes” in step S110, and the process proceeds to step S120. In contrast to this, if the execution instruction of the second operation is received, it is determined as “No” in step S110, and the process proceeds to step S122.

In step S120, the control unit 12 determines the suction force of the deodorizing unit 40 to be 80%.

On the other hand, in step S122, the control unit 12 determines the suction force of the deodorizing unit 40 to be 100%. The suction force of 100% indicates, for example, a state in which the rotation speed of the suction fan of the deodorizing unit 40 is set to the maximum value. The suction force of less than 100% is a numerical value based on 100% and is implemented by reducing the rotation speed of the suction fan in accordance with the numerical value. Obviously, numerical values such as 100% and 80% are merely examples. The suction force determined in step S120 may be smaller than the suction force determined in step S122.

In step S130 after step S120, the control unit 12 executes the first operation and drives the suction fan at a rotation speed corresponding to the suction force of, for example, 80% determined in step S120 to cause the deodorizing unit 40 to deodorize odor. The first operation is a process of performing a pass, that is, printing by ink discharge from the printing head 27 and irradiation while moving the carriage 26 from the start position P1 as described in FIG. 4A. At the same time as the printing head 27 performs the pass, the emitting unit 29 positioned behind the printing head 27 in the traveling direction of the carriage 26 along the main scanning direction D1 performs irradiation, and thus the ink dots landed on the medium 30 are immediately irradiated with ultraviolet rays and cured.

In contrast, in step S132 after step S122, the control unit 12 executes the second operation and drives the suction fan at a rotation speed corresponding to the suction force of, for example, 100% determined in step S122 to cause the deodorizing unit 40 to deodorize odor. The second operation is a process of performing only irradiation without executing ink discharge from the printing head 27 while moving the carriage 26 from the start position P1 as described with reference to FIG. 4A. Therefore, the second operation is based on the assumption that the medium 30 printed with ink is present on the table 33.

Obviously, the movement of the carriage 26 is not limited to the example in FIG. 4A. It is sufficient that printing and irradiation on the medium 30 can be executed without problems, and for example, the initial position P0 and the start position P1 may not be as illustrated. In a configuration in which the sub-scanning is performed not by the movement of the carriage 26 but by the conveyance of the medium 30, the initial position P0 may be regarded as the start position, and step S100 may be unnecessary. In this case, the movement of the carriage 26 in step S130 or step S132 is naturally only a reciprocating movement along the main scanning direction D1.

As described above, according to Example 1, the suction force of the deodorizing unit 40 is made stronger when the second operation is performed than when the first operation is performed. When the suction force is increased in parallel with the discharge of ink by the printing head 27, the mist of the ink easily flows toward the deodorizing unit 40, and the quality of the print result may be adversely affected. In Example 1, it is possible to deodorize the odor generated by the irradiation of ink with ultraviolet rays while avoiding such inconvenience.

### 2-2. Example 2

When printing by a printing unit 20 is finished, a control unit 12 may continue suction by a deodorizing unit 40 within a predetermined period from the end of the printing and may make the suction force of the deodorizing unit 40 weaker than that within the predetermined period after the elapse of the predetermined period. Since printing may be accompanied by irradiation as described above, the end of the printing may be interpreted as the end of the printing and the irradiation although it is not described in detail below.

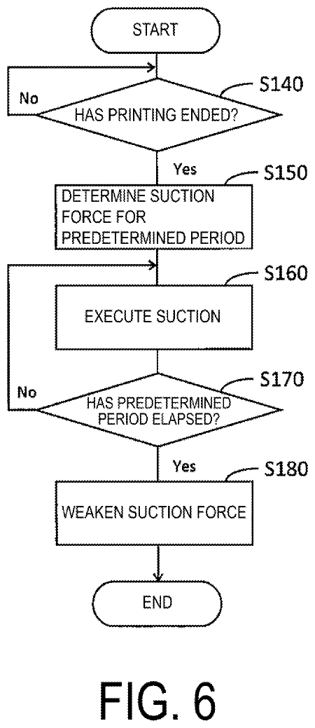

FIG. 6 is a flowchart illustrating Example 2.

In step S140, the control unit 12 repeatedly determines whether printing has been completed. For example, when a printing head 27 completes the last pass to a medium 30 and a carriage 26 returns to an initial position P0 as described Example 1, the control unit 12 determines that the printing is complete. Alternatively, the control unit 12 may determine that the printing is finished at a time point when the printing head 27 finishes the last pass with respect to the medium 30. Upon determining that the printing is finished, the control unit 12 proceeds from “Yes” in step S140 to step S150.

In step S150, the control unit 12 determines the suction force of the deodorizing unit 40 for a predetermined period after the end of printing. Since the suction fan of the deodorizing unit 40 is driven even during printing, the control unit 12 determines, for example, the suction force for the predetermined period to be the same suction force as during printing. Alternatively, the control unit 12 may determine the suction force for the predetermined period to be a suction force stronger than the suction force during printing. As Example 1, if the suction force of the deodorizing unit 40 during printing is 80%, the suction force for the predetermined period is set to, for example, 100%.

In step S160, the control unit 12 drives the suction fan at a rotation speed corresponding to the suction force determined in step S150 to cause the deodorizing unit 40 to deodorize odor. That is, the driving of the suction fan of the deodorizing unit 40 is continued even after the printing is finished. If the suction force determined in step S150 is the same as the suction force during printing, there is no difference between the driving of the suction fan in step S160 and the driving of the suction fan during printing.

In step S170, the control unit 12 determines whether or not a predetermined period has elapsed from the end of printing, that is, from the determination of “Ye” in step S140. If the predetermined period has not elapsed, the control unit continues step S160. In contrast to this, if the predetermined period has elapsed, the control unit proceeds from the determination of “Yes” to step S180. The predetermined period is a period whose length is determined in advance. Alternatively, as described later, the control unit 12 may determine the length of the predetermined period based on the print data used for printing and determine in step S170 whether the predetermined period of the determined length has elapsed.

In step S180, the control unit 12 makes the suction force of the deodorizing unit 40 weaker than the suction force in the above-described predetermined period. That is, the rotation speed of the suction fan of the deodorizing unit 40 is reduced. In step S180, reducing the suction force of the deodorizing unit 40 includes stopping the deodorizing unit 40, that is, stopping the rotation of the suction fan.

In the case in which the rotation of the suction fan is not stopped but weakened in step S180, the period for which the rotation of the suction fan is continued thereafter is not particularly limited in the present embodiment. Simply, when the user instructs to stop the deodorizing unit 40, the control unit 12 may stop the suction fan.

As described above, according to Example 2, the suction by the deodorizing unit 40 is continued at least for the predetermined period after the printing is finished, and thereafter, the suction force of the deodorizing unit 40 is weakened. Therefore, odor remaining after printing can be accurately deodorized, and power consumption can be suppressed.

### 2-3. Example 3

Example 3 is based on the premise that a printing system 10 is of the first type or the second type. The printing unit 20 and the deodorizing unit 40 are disposed in a housing having an openable and closable cover 13a. As shown in FIGS. 1A and 1B, the cover 13a is a part of the housing 13 of the printing apparatus 11, and the user can manually open and close the cover 13a. According to FIG. 1B, since the housing 13 of the printing apparatus 11 and a housing 15 of a deodorizing device 14 partially communicate with each other, even in the second type, the cover 13a is interpreted as a cover that opens and closes a part of the housing in which the printing unit 20 and the deodorizing unit 40 are disposed.

Upon completing printing by the printing unit 20, the control unit 12 continues the suction by the deodorizing unit 40 within a predetermined period from the end of the printing. This has been described in Example 2. The control unit 12 may notify the outside that the opening of the cover 13a is to be waited for during the predetermined period. Specific methods of notification include display of a message, an illustration, or a moving image by a display unit 21, lighting or blinking of an indicator (not illustrated), warning by voice from a speaker (not illustrated), and combinations thereof.

According to Example 3, it is possible to prevent odor from leaking to the outside of the housing due to the user opening the cover 13a during the predetermined period after the end of printing.

The control unit 12 can detect the opening and closing of the cover 13a. Accordingly, upon detecting that the cover 13a is opened during the predetermined period after the end of printing, the control unit 12 may notify the outside that the cover 13a should be closed until the predetermined period elapses.

The housing 13 may include a lock mechanism that prohibits or releases the opening of the cover 13a. The control unit 12 controls the lock mechanism. That is, the control unit 12 may forcibly prohibit the opening of the cover 13a by the lock mechanism not only during printing but also during a predetermined period after the end of printing and may release the lock mechanism to allow the cover 13a to be opened when the predetermined period has elapsed.

As described in Example 1, the printing unit 20 may irradiate a medium 30 without printing. Therefore, “printing” in Examples 2 and 3 may be replaced with “irradiation”, and Examples 2 and 3 may be applied to a predetermined period after the irradiation by an emitting unit 29 is finished.

### 2-4. Example 4

The printing unit 20 includes a maintenance box 34 that receives ink discharged from nozzles 28 by a printing head 27 to recover the function of the nozzles 28. The recovery of the function of the nozzle 28 refers to the elimination of clogging of the nozzle 28. The maintenance box 34 is hereinafter abbreviated as the MTB 34. The control unit 12 can execute so-called flushing in which the printing head 27 is caused to discharge ink from the nozzles 28 for the function recovery after moving the printing head 27 to the position of the MTB 34. The flushing and the movement of the printing head 27 are one type of operation of the printing unit 20. The control unit 12 may make the suction force of a deodorizing unit 40 stronger during the flushing period in which the printing head 27 discharges ink from the nozzles for function recovery at the position of the MTB 34 than during a period different from the flushing period.

FIG. 4A exemplarily shows the position of the MTB 34. The MTB 34 is provided within a range in which a carriage 26 can move, which is different from a range in or through which a medium 30 is placed or passes. In the example in FIG. 4A, the MTB 34 is disposed at a predetermined position outside a table 33. The position of the carriage 26 in which a nozzle surface 27a of the printing head 27 faces the MTB 34 is referred to as a flushing position.

The control unit 12 performs flushing upon accepting a flushing execution instruction by the operation of an operation accepting unit 22 by a user or communication from an external device via a communication IF 23 or at a predetermined flushing execution timing. Referring to FIG. 4A, in order to perform flushing, the control unit 12 first moves the carriage 26 from an initial position P0 to the position of the MTB 34, that is, the flushing position. Then, the control unit 12 executes flushing in a state in which the carriage 26 is stopped at the flushing position and returns the carriage 26 to the initial position P0 after completion of the flushing.

Therefore, the period during which the carriage 26 is stopped at the flushing position can be regarded as a flushing period. The period during which the carriage 26 moves from the initial position P0 to the flushing position and the period during which the carriage 26 moves from the flushing position to the initial position P0 can be regarded as a kind of period different from the flushing period.

As described above, according to the fourth embodiment, the control unit 12 makes the suction force of the deodorizing unit 40 stronger during the flushing period than during a period different from the flushing period, thereby reliably deodorizing a strong odor generated by flushing and suppressing power consumption as a whole.

### 2-5. Example 5

Example 5 is based on the premise that a printing system 10 is of the first type. The printing system 10 may include a plurality of deodorizing units 40. Here, it is assumed that the printing system 10 includes a first deodorizing unit 40a and a second deodorizing unit 40b each functioning as the deodorizing unit 40. However, the number of deodorizing units 40 may be more than two.

As in Example 4, also in Example 5, a printing unit 20 includes an MTB 34 that receives the ink that a printing head 27 discharges from nozzles 28 for the function recovery of the nozzles 28, and a control unit 12 can perform flushing to cause the printing head 27 to discharge ink from the nozzles 28 for the function recovery after moving the printing head 27 to the position of the MTB 34. Then, the control unit 12 may make the suction force of one of the first deodorizing unit 40a and the second deodorizing unit 40b which is closer to the MTB 34 weaker than the suction force of one of the first deodorizing unit 40a and the second deodorizing unit 40b which is farther from the MTB 34 during the flushing period in which the printing head 27 discharges ink from the nozzles 28 for the function recovery at the position of the MTB 34.

FIG. 4B schematically illustrates a configuration in which the first deodorizing unit 40a and the second deodorizing unit 40b are disposed in a housing 13 of a printing apparatus 11 from the same viewpoint as in FIG. 4A. Referring to FIG. 4B, any description common to FIG. 4A is omitted. According to FIG. 4B, the deodorizing units 40 are respectively disposed between two or more of the four sides of a table 33 and the inner wall of the housing 13. Here, the deodorizing unit 40 located downstream of the table 33 in a sub-scanning direction D2 is referred to as the first deodorizing unit 40a, and the deodorizing unit 40 located upstream of the first deodorizing unit 40b in the sub-scanning direction D2 and at a position relatively close to the MTB 34 is referred to as the second deodorizing unit 40b. That is, in the example in FIG. 4B, the second deodorizing unit 40b is closer to the MTB 34 than the first deodorizing unit 40a.

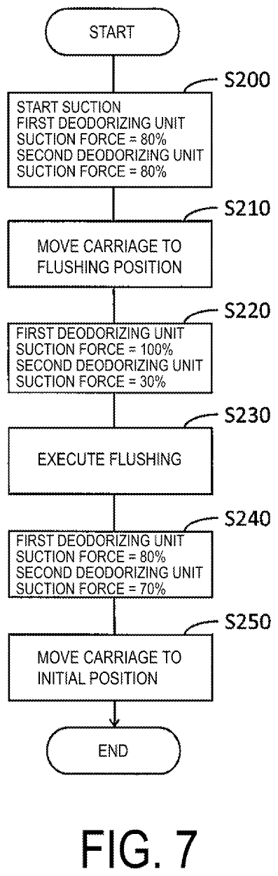

FIG. 7 is a flowchart illustrating Example 5. The control unit 12 executes the flowchart of FIG. 7 when starting flushing.

In step S200, the control unit 12 determines that the suction force of the first deodorizing unit 40a is 80%, determines that the suction force of the second deodorizing unit 40b is 80%, and starts driving the suction fans of the first deodorizing unit 40a and the second deodorizing unit 40b at a rotation speed corresponding to the determined suction force to deodorize the odor. Each numerical value illustrated in the flowchart of FIG. 7 is merely an example similarly to each numerical value illustrated in FIG. 5.

In Step S210, the control unit 12 moves the carriage 26 from the initial position P0 to the flushing position.

In step S220, the control unit 12 changes the suction force of each deodorizing unit 40. For example, the suction force of the first deodorizing unit 40a is changed to 100%, the suction force of the second deodorizing unit 40b is changed to 30%, and the suction fans of the first deodorizing unit 40a and the second deodorizing unit 40b are driven at rotation speeds corresponding to the changed suction forces.

In step S230, the control unit 12 causes the printing head 27 to perform flushing. That is, the suction force after the change in step S220 becomes the suction force in the flushing period. After the flushing is finished, in step S240, the control unit 12 changes the suction force of each deodorizing unit 40. For example, the suction force of the first deodorizing unit 40a is changed to 80%, the suction force of the second deodorizing unit 40b is changed to 70%, and the suction fans of the first deodorizing unit 40a and the second deodorizing unit 40b are driven at rotation speeds corresponding to the changed suction forces.

In Step S250, the control unit 12 moves the carriage 26 from the flushing position to the initial position P0.

According to step S220 and step S240 in FIG. 7, the suction force of the second deodorizing unit 40b close to the MTB 34 is made weaker than that of the first deodorizing unit 40a far from the MTB 34. In particular, according to the step S220, during the flushing period, the suction force of the second deodorizing unit 40b close to the MTB 34 is greatly inferior to that of the first deodorizing unit 40a far from the MTB 34.

It was confirmed that in the flushing period in which ink is forcibly discharged from the printing head 27 toward the MTB 34, if the odor is strongly sucked by the deodorizing unit 40 at a position close to the MTB 34, the odor easily leaks to the outside of the housing 13 of the printing apparatus 11. In Example 5, in order to handle such a problem, during the flushing period, the suction force of the deodorizing unit 40 of the first deodorizing unit 40a and the second deodorizing unit 40b which is closer to the MTB 34 is made weaker than the suction force of the deodorizing unit 40 of the first deodorizing unit 40a and the second deodorizing unit 40b which is farther from the MTB 34. This makes it possible to suppress the leakage of odor to the outside of the housing 13.

According to the flowchart of FIG. 7, focusing on changes in the suction force of the first deodorizing unit 40a, the suction force is 80% in the period before the flushing period, 100% in the flushing period, and 80% in the period after the flushing period. It can be said that this specifically illustrates Example 4 in which the suction force of the deodorizing unit 40 is stronger during the flushing period than during a period different from the flushing period. That is, the flowchart of FIG. 7 specifically shows both Example 4 and Example 5. Focusing on changes in the suction force of the second deodorizing unit 40b, the suction force is 80% in the period before the flushing period, 30% in the flushing period, and 70% in the period after the flushing period. It can be said that this specifically illustrates Example in which the suction force of the deodorizing unit 40 is weaker during the flushing period than during a period different from the flushing period.

The flushing includes a process called flushing at the time of initial ink filling. At the time of initial filling, that is, when an ink supply unit called an ink cartridge, an ink tank, an ink bottle, or the like is newly attached to or connected to the printing head 27, the printing head 27 flushes the ink filled from the ink supply unit as one of the initial operations of the printing unit 20. Also with regard to the flushing at the time of the initial filling, the control unit 12 may provide a difference in the suction force of the deodorizing unit 40 between the period in which the flushing is executed and the periods before and after the flushing so as to effectively deodorize the odor generated at the time of the flushing.

### 2-6. Example 6

As described above, a printing head 27 can reciprocate along each of a predetermined main scanning direction D1 with respect to the medium 30 and a sub-scanning direction D1 intersecting with the main scanning direction D2. The control unit 12 may change the suction force of a deodorizing unit 40 according to the position of the printing head 27.

A control unit 12 grasps the position of a carriage 26 as the position of the printing head 27 and, for example, grasps a position leaving an initial position P0 to until reaching a start position P1 as a first position, a position from a start position P1 to immediately before reaching the initial position P0 as a second position, and the initial position P0 returning from the start position P1 as a third position. Then, the control unit 12 changes the suction force by changing the rotation speed of the suction fan of the deodorizing unit 40 depending on whether the current position of the printing head 27 is the first position, the second position, or the third position. For example, the control unit 12 sets the suction force at the first position<the suction force at the second position<the suction force at the third position. The, the control unit 12 can change the suction force of the deodorizing unit 40 depending on whether the position of the printing head 27 is at the flushing position or not.

The control of the deodorizing unit 40 according to Example 6 may be partially common to Examples 2 to 4 only in terms of results. However, Example 6 is characterized in that the suction force of the deodorizing unit 40 is changed in accordance with the position of the printing head 27 as the operation result of the printing unit 20. According to Example 6, by changing the suction force of the deodorizing unit 40 in accordance with the position of the printing head 27, it is possible to optimize the suction force of the deodorizing unit 40 and to avoid a situation in which the suction force for deodorization is stronger or weaker than necessary.

### 2-7. Example 7

The printing head 27 can discharge color ink and varnish ink as UV curable ink in accordance with print data. Print data include print data and is input from an external device via a communication IF 23 or is input from an external memory (not illustrated). Alternatively, print data may include image data representing an image to be printed, and the control unit 12 may generate print data by performing color conversion processing, halftone processing, or the like on the image data as appropriate. In any case, the type of ink discharged by the printing head 27, the data size of an image to be printed, and the like are known from print data. The addition, the print data includes, for example, information designating the emission intensity of an emitting unit 29 and an instruction to execute only irradiation without executing printing. Since irradiation is a process required to complete a printed matter, an instruction to execute only irradiation without executing printing is also regarded as a type of print data.

The control unit 12 may increase the suction force of a deodorizing unit 40 when the printing head 27 discharges varnish ink to perform printing as compared with the case in which the printing head 27 performs printing without discharging the varnish ink. The control unit 12 analyzes print data representing an image to be printed on a medium 30 and determines whether or not it is necessary to discharge varnish ink. When the discharge of the varnish ink is necessary, the suction force of the deodorizing unit 40 during printing, for example, during the period of step S130 in FIG. 5 is increased as compared with the case in which the discharge of the varnish ink is not necessary.

As an example, when color inks of C, M, Y, and K are discharged and the varnish ink is not discharged in the printing in step S130, the control unit 12 determines the suction force to be 80% in step S120 as illustrated in FIG. 5. In contrast, if varnish ink is also discharged in addition to color ink in the printing in step S130, the suction force may be determined to be 90% or 95% in step S120. Varnish ink has a stronger odor than other color inks. According to Example 7, the strong odor generated from varnish ink can be reliably deodorized.

### 2-8. Example 8

A control unit 12 may increase the suction force of a deodorizing unit 40 in accordance with the amount of ink calculated based on the data size of the image to be printed indicated by print data and the density of the image. As described above, print data includes image data or print data representing an image to be printed. The data size of an image is the number of pixels in the vertical and horizontal directions, and the density of the image can be grasped from the gradation value of the color of each pixel and dot on/off information. Therefore, the control unit 12 calculates the amount of ink that the printing head 27 should discharge to print an image based on the data size and density of the image. Then, the control unit 12 determines the suction force of the deodorizing unit 40 to a stronger value as the calculated amount of ink is larger and drives the suction fan of the deodorizing unit 40 during printing at a rotation speed corresponding to the determined suction force.

According to Example 8 described above, since the suction force of the deodorizing unit 40 is controlled in accordance with the amount of ink discharged for printing an image, it is possible to appropriately deodorize odors of different degrees in accordance with the amount of ink. Obviously, Example 8 can be applied to steps S120 and S130 in FIG. 5.

The concept of increasing the suction force of the deodorizing unit 40 includes increasing the period during which the suction fan is driven. Therefore, the control unit 12 may determine the suction force of the deodorizing unit 40 after the end of printing to be a stronger value as the amount of ink calculated as described above is larger and may cause the deodorizing unit 40 to perform deodorization even after the end of printing. That is, the rotation speed of the suction fan of the deodorizing unit 40 in the “predetermined period” after the end of printing described in Example 2 or 3 and the length of the predetermined period may be determined and adopted in accordance with the amount of ink discharged for printing an image.

### 2-9. Example 9

Similar to Example 3, Example 9 is based on the premise that a printing system 10 is of the first type or the second type. The printing unit 20 and the deodorizing unit 40 are disposed in a housing having an openable and closable cover 13a. When the cover 13a is opened by the operation of the user, the control unit 12 may increase the suction force of the deodorizing unit 40 more than when the cover 13a is closed. Since the cover 13a can be regarded as a cover that covers the printing unit 20 from the outside, the user's operation of opening or closing the cover 13a is one type of user's operation on the printing unit 20.

As described above, the control unit 12 drives the suction fan of the deodorizing unit 40 at various timings and periods such as during the execution of printing and irradiation, during execution of only irradiation, during the flushing period, during periods before and after the flushing period, and during a predetermined period after the completion of printing. Upon detecting the opening of the cover 13a during the driving of the deodorizing unit 40, the control unit 12 makes the suction force of the deodorizing unit 40 stronger than the preceding suction force and continues the driving of the deodorizing unit 40. According to Example 9, the amount of odor leaking to the outside of the housing when the user opens the cover 13a can be suppressed as much as possible.

Upon detecting that the cover 13a is closed from the opened state during the driving of the deodorizing unit 40, the control unit 12 may reduce the power consumption by making the suction force of the deodorizing unit 40 weaker than the preceding suction force.

Obviously, the operation performed on the printing unit 20 by the user is not limited to the opening and closing the cover 13a. For example, the control unit 12 may start driving the deodorizing unit 40 upon detecting that the power of the printing unit 20 is turned on by the user. In addition, the control unit 12 may start driving the deodorizing unit 40 or change the suction force thereof in accordance with various instructions to perform, for example, printing, irradiation, flushing, and the like, which are input as operations of the operation accepting unit 22 by the user.

### 3. CONCLUSION

As described above, according to the present embodiment, the printing system 10 includes the printing unit 20 that includes the printing head 27 configured to discharge UV curable ink from the plurality of nozzles 28 to the medium 30 and is configured to execute printing, the deodorizing unit 40 configured to suck the odor generated from the UV curable ink, and the control unit 12 configured to control the printing unit 20 and the deodorizing unit 40. The control unit 12 controls the suction by the deodorizing unit 40 according to any one of the operation of the printing unit 20, print data input from the outside for printing, and the operation on the printing unit 20 by the user.

According to the above configuration, the control unit 12 controls the suction by the deodorizing unit 40 according to any one of the elements such as the operation of the printing unit 20, print data, and the operation on the printing unit 20 by the user. Therefore, as described in each Example, the suction by the deodorizing unit 40 can be flexibly changed and optimized according to the situation. This makes it possible to prevent the print quality from being affected by the excessive deodorization, the electric power from being unnecessarily consumed, and the deodorization from being insufficient as compared with known techniques.

Note that, in the scope of the claims, only some of the combinations of the claims are described. However, as a matter of course, the present embodiment includes various combinations of the plurality of dependent claims, as well as one-to-one combinations of the independent claims and the dependent claims.

In addition to the printing system 10, the present embodiment discloses disclosures in categories such as a method by processes and steps executed by the printing system 10, a program 124 for implementing the method in cooperation with a processor, the printing apparatus 11, and the deodorizing device 14.

What is claimed is:

1. A printing system comprising:
a printing unit that includes a printing head configured to discharge UV curable ink from a plurality of nozzles to a medium and configured to execute printing;
a deodorizing unit configured to suck odor generated from the UV curable ink; and
a control unit configured to control the printing unit and the deodorizing unit, wherein
the control unit controls suction by the deodorizing unit according to any one of an operation of the printing unit, print data input from outside for printing, and an operation on the printing unit by a user.

2. The printing system according to claim 1, wherein
the printing unit includes an emitting unit configured to irradiate the UV curable ink discharged onto the medium by the printing head with ultraviolet light, and
the control unit makes a suction force of the deodorizing unit stronger at time of executing a second operation of only performing irradiation out of discharge of the UV curable ink by the printing head and the irradiation by the emitting unit than at time of executing a first operation of simultaneously performing discharge of the UV curable ink by the printing head and the irradiation by the emitting unit.

3. The printing system according to claim 1, wherein
when printing by the printing unit is finished, the control unit continues suction by the deodorizing unit within a predetermined period from end of the printing and makes the suction force of the deodorizing unit weaker than the suction force within the predetermined period after elapse of the predetermined period.

4. The printing system according to claim 1, wherein
the printing unit and the deodorizing unit are disposed in a housing having an openable and closable cover, and
the control unit continues, upon end of printing by the printing unit, suction by the deodorizing unit within a predetermined period from the end of the printing and gives outside, during the predetermined period, a notification that opening of the cover is to be waited.

5. The printing system according to claim 1, wherein
the printing unit includes a maintenance box configured to receive the UV curable ink discharged from the nozzle by the printing head for function recovery of the nozzle, and
the control unit is configured to cause the printing head to discharge the UV curable ink from the nozzle for the function recovery after moving the printing head to a position of the maintenance box and makes a suction force of the deodorizing unit stronger during a flushing period in which the printing head discharges the UV curable ink from the nozzle for the function recovery at the position of the maintenance box than a period different from the flushing period.

6. The printing system according to claim 1, wherein
the printing unit and the deodorizing unit are disposed in a common housing,
the printing system comprises a first deodorizing unit and a second deodorizing unit each functioning as the deodorizing unit,
the printing unit includes a maintenance box configured to receive the UV curable ink discharged from the nozzle by the printing head for function recovery of the nozzle, and
the control unit is configured to cause the printing head to discharge the UV curable ink from the nozzle for the function recovery after moving the printing head to a position of the maintenance box and makes a suction force of one of the first deodorizing unit and the second deodorizing unit that is closer to the maintenance box weaker than a suction force of one of the first deodorizing unit and the second deodorizing unit that is farther from the maintenance box during a flushing period in which the printing head discharges the UV curable ink from the nozzle for the function recovery at the position of the maintenance box.

7. The printing system according to claim 1, wherein
the printing head is configured to reciprocate along each of a predetermined main scanning direction with respect to the medium and a sub-scanning direction intersecting the main scanning direction, and
the control unit changes the suction force of the deodorizing unit according to a position of the printing head.

8. The printing system according to claim 1, wherein
the printing head is configured to discharge color ink and varnish ink as the UV curable ink in accordance with the print data, and
the control unit makes the suction force of the deodorizing unit stronger in a case in which the printing head executes printing by discharging the varnishing ink than in a case in which the printing head performs printing without discharging the varnishing ink.

9. The printing system according to claim 1, wherein
the control unit increases the suction force of the deodorizing unit in accordance with an ink amount of the UV curable ink calculated based on a data size of an image to be printed indicated by the print data and a density of the image.

10. The printing system according to claim 1, wherein
the printing unit and the deodorizing unit are disposed in a housing having an openable and closable cover, and
the control unit makes a suction force of the deodorizing unit stronger when the cover is opened by the operation by the user than when the cover is closed.
